(19) United States
(12) Patent Application Publication
(10) Pub. No.: US 2026/0229735 A1
(43) Pub. Date: Aug. 6, 2026

(54) ENERGY STORAGE DEVICE

(71) Applicant: TOYOTA JIDOSHA KABUSHIKI KAISHA, Toyota-shi (JP)

(72) Inventor: Shuichi NISHIDA, Toyota-shi (JP)

(73) Assignee: TOYOTA JIDOSHA KABUSHIKI KAISHA, Toyota-shi (JP)

(21) Appl. No.: 19/388,805

(22) Filed: Nov. 13, 2025

(30) Foreign Application Priority Data
Feb. 4, 2025 (JP) 2025-016897

(51) Int. Cl. H01M 50/581; H01M 10/42; H01M 10/653; H01M 10/654; H01M 50/586

(52) U.S. Cl. CPC H01M 50/581; H01M 10/4235; H01M 10/653; H01M 10/654; H01M 50/586

(57) ABSTRACT

An energy storage device includes: an electrode assembly including positive and negative electrodes; a plate member; and an electrically conductive layer interposed between the electrode assembly and the plate member. The electrically conductive layer includes: a first metal portion having the form of a plate and having a first surface that contacts the electrode assembly; a second metal portion having the form of a plate and having a second surface that contacts the plate member; and an insulating portion disposed in a central region of the first surface of the first metal portion and in contact with the electrode assembly. A third surface of the first metal portion opposite to the first surface and a fourth surface of the second metal portion opposite to the second surface face each other and are connected together. The first metal portion has a higher coefficient of thermal expansion than the second metal portion.

### CROSS-REFERENCE TO RELATED APPLICATION

This application claims priority to Japanese Patent Application No. 2025-016897 filed on February 4, 2025. The disclosure of the above-identified application, including the specification, drawings, and claims, is incorporated by reference herein in its entirety.

### BACKGROUND

### Technical Field

The present disclosure relates to energy storage devices.

### Description of Related Art

In the energy storage device disclosed in Japanese Unexamined Patent Application Publication No. 2009-16235 (JP 2009-16235 A), an electrically conductive member is in contact with an energy storage element, and the electrically conductive member thermally deforms with temperature changes. This thermal deformation changes the contact area between the energy storage element and the electrically conductive member.

### SUMMARY

When the electrically conductive member remains in contact with the energy storage element even after the thermal deformation, current flows between the electrically conductive member and the energy storage element, which may cause the energy storage element to become excessively heated.

The present disclosure has been made in view of the above issue, and an object thereof is to provide an energy device capable of suppressing excessive heating of an electrode assembly.

In order to address the above issue and achieve the object, an energy storage device according to the present disclosure includes: an electrode assembly including a positive electrode and a negative electrode; a plate member; and an electrically conductive layer interposed between the electrode assembly and the plate member. The electrically conductive layer includes: a first metal portion having the form of a plate and having a first surface that contacts the electrode assembly; a second metal portion having the form of a plate and having a second surface that contacts the plate member; and an insulating portion disposed in a central region of the first surface of the first metal portion and in contact with the electrode assembly. A third surface of the first metal portion and a fourth surface of the second metal portion face each other and are connected together. The third surface is a surface opposite to the first surface, and the fourth surface is a surface opposite to the second surface. The coefficient of thermal expansion of the first metal portion is higher than that of the second metal portion.

Accordingly, in the energy storage device according to the present disclosure, when the electrically conductive layer is heated, the electrically conductive layer warps such that its central region protrudes toward the electrode assembly and its peripheral edge region separates away from the electrode assembly due to the difference in coefficient of thermal expansion between the first metal portion and the second metal portion. When the electrically conductive layer has warped in this way, the electrically conductive layer contacts the electrode assembly at the insulating portion, while the first metal portion does not contact the electrode assembly. Therefore, in the energy storage device according to the present disclosure, when the electrically conductive layer is heated and becomes hot, the current path through which current would flow from the electrically conductive layer to the electrode assembly can be cut off, and current cannot flow through the electrode assembly. Excessive heating of the electrode assembly by Joule heat can thus be suppressed.

In the above energy storage device, the plate member may include a lower plate and an upper plate, and the electrically conductive layer may include a lower current collector plate interposed between the electrode assembly and the lower plate, and an upper current collector plate interposed between the electrode assembly and the upper plate.

With this configuration, when the lower current collector plate and the upper current collector plate warp due to heating, the current path between the lower current collector plate and the electrode assembly through which current would flow and the current path between the upper current collector plate and the electrode assembly through which current would flow are cut off, thereby suppressing excessive heating of the electrode assembly by Joule heat.

The energy storage device according to the present disclosure can suppress excessive heating of the electrode assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a schematic configuration of an energy storage device according to an embodiment;

FIG. 2 is a schematic view of a lower current collector plate as viewed from above;

FIG. 3 is a diagram showing a state in which the lower current collector plate has warped in the energy storage device according to the embodiment; and

FIG. 4 is a diagram showing a state in which the lower current collector plate and an upper current collector plate have warped in the energy storage device according to the embodiment.

### DETAILED DESCRIPTION OF EMBODIMENTS

An energy storage device according to an embodiment of the present disclosure will be described below. The present disclosure is not limited to the embodiment.

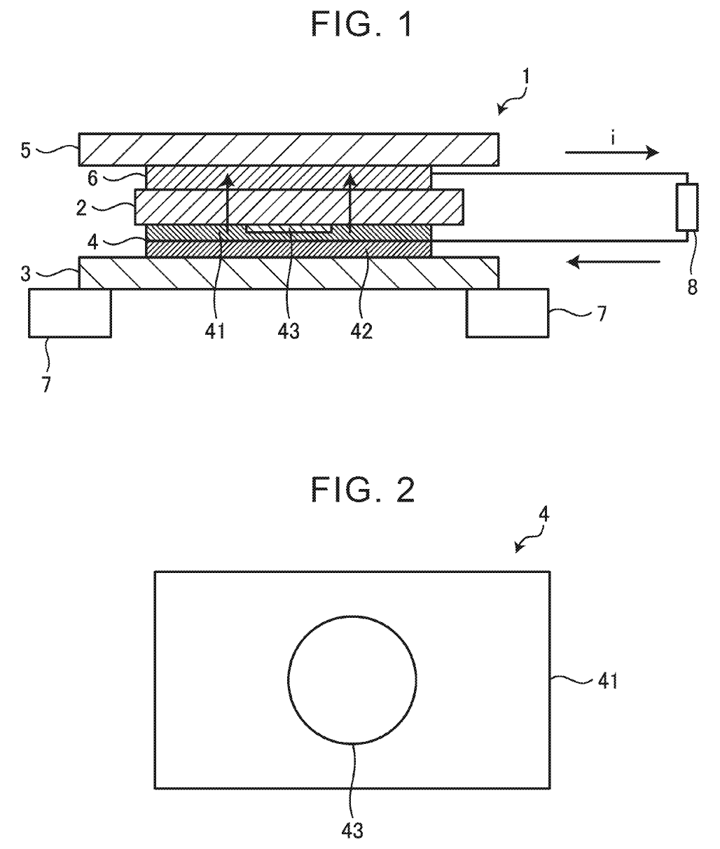

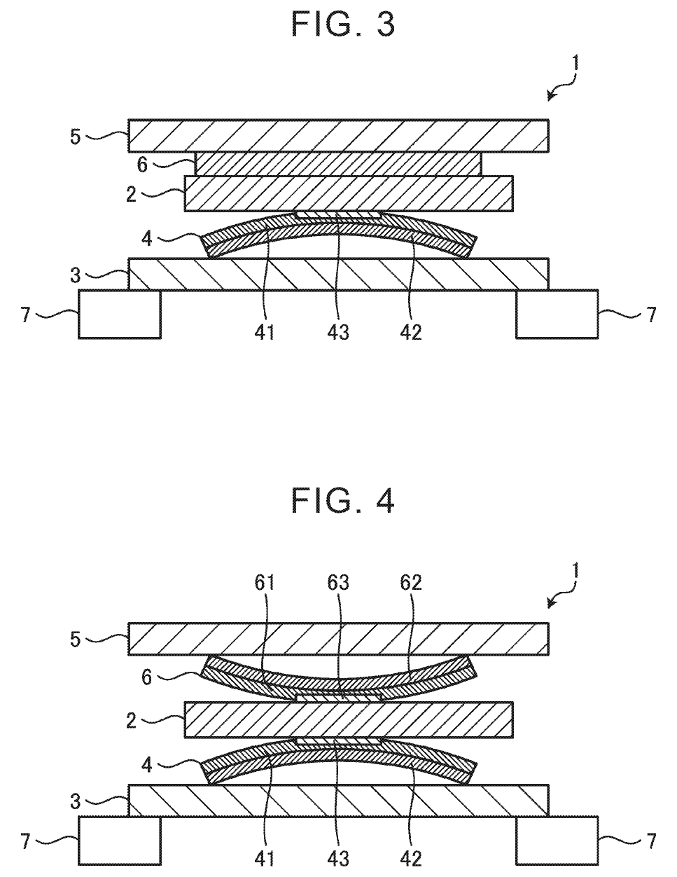

FIG. 1 is a sectional view showing a schematic configuration of an energy storage device 1 according to the embodiment. FIG. 2 is a schematic view of a lower current collector plate 4 as viewed from above. FIG. 3 is a diagram showing a state in which the lower current collector plate 4 has warped in the energy storage device 1 according to the embodiment.

The energy storage device 1 according to the embodiment includes a battery module 2, a lower plate 3, a lower current collector plate 4, an upper plate 5, and an upper current collector plate 6. The energy storage device 1 is installed with the lower plate 3 placed on a base 7.

The battery module 2 is an electrode assembly having a positive electrode and a negative electrode, and is formed of, for example, a stack of a plurality of bipolar electrode assemblies. The battery module 2 is a large electrode assembly in the form of a plate, with its longitudinal and lateral dimensions being, for example, at least 1 m.

The lower current collector plate 4 is a bimetal plate formed by bonding together two metal plates having different coefficients of thermal expansion, and serves as an electrically conductive layer interposed between the battery module 2 and the lower plate 3. The lower current collector plate 4 includes a first metal plate 41, a second metal plate 42, and an insulator 43. The first metal plate 41 is a first metal portion having a front surface, which is a first surface, that contacts the battery module 2. The second metal plate 42 is a second metal portion having a front surface, which is a second surface, that contacts the lower plate 3. The insulator 43 is an insulating portion that is disposed in a central region of the front surface of the first metal plate 41 and is in contact with the battery module 2. The first metal plate 41 and the insulator 43 are not bonded to the battery module 2, and the second metal plate 42 is not bonded to the lower plate 3.

The back surface of the first metal plate 41, which is a third surface, and the back surface of the second metal plate 42, which is a fourth surface, face each other and are connected together. The back surface of the first metal plate 41 is the surface opposite to its front surface, and the back surface of the second metal plate 42 is likewise the surface opposite to its front surface. The first metal plate 41 and the second metal plate 42 have the same thickness. The coefficient of thermal expansion of the first metal plate 41 is higher than that of the second metal plate 42. Examples of combinations of the first metal plate 41 and the second metal plate 42 (first metal plate 41/second metal plate 42) include Ni–Fe/Cu, Ni–Fe/Ni, and Ni–Fe/Cu–Zn.

The insulator 43 is not electrically conductive, and may be formed of, for example, ceramics or resin. As shown in FIG. 2, the insulator 43 is circular in shape, and is disposed in the central region of the first metal plate 41 (lower current collector plate 4) in the planar direction so as to correspond to the central region of the battery module 2 in the planar direction. The insulator 43 and the first metal plate 41 may not be bonded together or may be bonded together. For example, the insulator 43 and the first metal plate 41 may be bonded together by providing a hole in the central region of the first metal plate 41 in the planar direction and fixing the insulator 43 in the hole with a heat-resistant adhesive.

For example, in the energy storage device 1 according to the embodiment, as shown in FIG. 1, a circuit is formed by the battery module 2, the upper current collector plate 6, a short-circuit resistor 8, and the lower current collector plate 4 when an external short-circuit occurs. When a short-circuit current (overcurrent) i flows through the circuit due to the external short-circuit, the battery module 2, the lower current collector plate 4, and the upper current collector plate 6 are heated by Joule heat. As a result, as shown in FIG. 3, because of the difference in coefficient of thermal expansion between the first metal plate 41 and the second metal plate 42, the lower current collector plate 4 warps such that its central region protrudes toward the battery module 2 and its peripheral edge region separates away from the battery module 2. When the lower current collector plate 4 has warped in this way, as shown in FIG. 3, the lower current collector plate 4 contacts the battery module 2 at the insulator 43, while the first metal plate 41 does not contact the battery module 2. As a result, the current path between the lower current collector plate 4 and the battery module 2 through which the short-circuit current i would flow can be cut off, and the short-circuit current i cannot flow through the battery module 2. Excessive heating of the battery module 2 by Joule heat can thus be suppressed.

FIG. 4 is a diagram showing a state in which the lower current collector plate 4 and the upper current collector plate 6 have warped in the energy storage device 1 according to the embodiment.

In the energy storage device 1 according to the embodiment, as shown in FIG. 4, the upper current collector plate 6, in addition to the lower current collector plate 4, also includes a first metal plate 61, a second metal plate 62, and an insulator 63. The first metal plate 61 is a first metal portion having a front surface that contacts the battery module 2. The second metal plate 62 is a second metal portion having a front surface that contacts the upper plate 5. The insulator 63 is an insulating portion that is disposed in a central region of the front surface of the first metal plate 61 and is in contact with the battery module 2. The first metal plate 61 and the insulator 63 are not bonded to the battery module 2, and the second metal plate 62 is not bonded to the upper plate 5.

The back surface of the first metal plate 61 and the back surface of the second metal plate 62 face each other and are connected together. The first metal plate 61 and the second metal plate 62 have the same thickness. The coefficient of thermal expansion of the first metal plate 61 is higher than that of the second metal plate 62. Examples of combinations of the first metal plate 61 and the second metal plate 62 (first metal plate 61/second metal plate 62) include Ni–Fe/Cu, Ni–Fe/Ni, and Ni–Fe/Cu–Zn. The insulator 63 is not electrically conductive, and may be formed of, for example, ceramics or resin. The insulator 63 is circular in shape, and is disposed in the central region of the first metal plate 61 (upper current collector plate 6) in the planar direction so as to correspond to the central region of the battery module 2 in the planar direction.

In the energy storage device 1 shown in FIG. 4, when a circuit is formed by the battery module 2, the upper current collector plate 6, the short-circuit resistor, and the lower current collector plate 4 due to an external short-circuit and a short-circuit current (overcurrent) flows through the circuit, the battery module 2, the lower current collector plate 4, and the upper current collector plate 6 are heated by Joule heat. As a result, because of the difference in coefficient of thermal expansion between the first metal plate 41 and the second metal plate 42, the lower current collector plate 4 warps such that its central region protrudes toward the battery module 2 and its peripheral edge region separates away from the battery module 2. Accordingly, the lower current collector plate 4 contacts the battery module 2 at the insulator 43, while the first metal plate 41 does not contact the battery module 2. Similarly, as shown in FIG. 4, because of the difference in coefficient of thermal expansion between the first metal plate 61 and the second metal plate 62, the upper current collector plate 6 warps such that its central region protrudes toward the battery module 2 and its peripheral edge region separates away from the battery module 2. Accordingly, the upper current collector plate 6 contacts the battery module 2 at the insulator 63, while the first metal plate 61 does not contact the battery module 2. As a result, in the energy storage device 1 shown in FIG. 4, the current path between the lower current collector plate 4 and the battery module 2 through which the short-circuit current would flow and the current path between the upper current collector plate 6 and the battery module 2 through which the short-circuit current would flow can be cut off. Therefore, the short-circuit current cannot flow through the battery module 2. Excessive heating of the battery module 2 by Joule heat can thus be suppressed.

In the energy storage device 1 according to the embodiment, either the lower current collector plate 4 or the upper current collector plate 6, or both, may be configured to warp when heated, as described above.

What is claimed is:

1. An energy storage device comprising:
an electrode assembly including a positive electrode and a negative electrode;
a plate member; and
an electrically conductive layer interposed between the electrode assembly and the plate member, wherein:
the electrically conductive layer includes
a first metal portion having a form of a plate and having a first surface that contacts the electrode assembly,
a second metal portion having a form of a plate and having a second surface that contacts the plate member, and
an insulating portion disposed in a central region of the first surface of the first metal portion and in contact with the electrode assembly;
a third surface of the first metal portion and a fourth surface of the second metal portion face each other and are connected together, the third surface being a surface opposite to the first surface, and the fourth surface being a surface opposite to the second surface; and
a coefficient of thermal expansion of the first metal portion is higher than a coefficient of thermal expansion of the second metal portion.

2. The energy storage device according to claim 1, wherein:
the plate member includes a lower plate and an upper plate; and
the electrically conductive layer includes a lower current collector plate interposed between the electrode assembly and the lower plate, and an upper current collector plate interposed between the electrode assembly and the upper plate.
